(19) United States
(12) Patent Application Publication
(10) Pub. No.: US 2002/0016868 A1
(43) Pub. Date: Feb. 7, 2002

(54) METHOD AND APPARATUS FOR SERIAL PORT SHARING

(75) Inventor: GAVIN MURRAY PEACOCK, PLEASANT HILL, CA (US)

Correspondence Address: WILSON SONSINI GOODRICH & ROSATI, 650 PAGE MILL ROAD, PALO ALTO, CA, 943041050

(73) Assignee: Palm, Inc.

(21) Appl. No.: 09/078,357

(22) Filed: May 13, 1998

(51) Int. Cl. G06F 9/00; G06F 9/54; G06F 15/163; G06F 13/10

(52) U.S. Cl. 709/321

(57) ABSTRACT

A method and apparatus for sharing a serial port is disclosed. In the following description, for purposes of explanation, specific nomenclature is set forth to provide a thorough understanding of the present invention. However, it will be apparent to one skilled in the art that these specific details are not required in order to practice the present invention. For example, the present invention has been described with reference to a serial port that is shared between an infrared sniffer program and application programs. However, the same techniques can easily be applied to other types of computer hardware resources and other types of programs that need frequent access to a scarce computer hardware resource.

### FIELD OF THE INVENTION

The present invention relates to the field of computer operating systems software. In particular the present invention discloses a hardware device driver.

### BACKGROUND OF THE INVENTION

Modern computer operating systems support several application programs executing concurrently. To share the physical hardware resources of a computer system among a plurality of concurrently executing application programs, the operating system accepts hardware resource requests from the various application programs. In response to a request from an application program, the operating system will give control of a particular hardware resource to the requesting application program. When the application program releases control, the operating system can then give the hardware resource to another requesting application program.

In some situations, it would be desirable to allow one particular application nearly full-time access to a particular hardware resource, yet allow other applications to occasionally use the hardware resource. A simple request and release sharing mechanism does not work for such applications. It would therefore be desirable to have a method of allowing one application to dominate the usage of a particular hardware resource yet let other applications have access to the hardware resource when needed.

### SUMMARY OF THE INVENTION

A method of sharing a particular hardware resource in a computer system is disclosed. In the method of the present invention, one or more applications are allowed to monitor a particular hardware resource. The monitoring applications may monitor the hardware resource as long as no other applications have requested exclusive access to the hardware resource. When an application needs exclusive access to the hardware resource, the operating system then gives exclusive control to that application. When that application is finished using the hardware resource, control is returned to the operating system which then allows the other applications to monitor the hardware resource.

Other objects feature and advantages of present invention will be apparent from the company drawings and from the following detailed description that follows below.

### BRIEF DESCRIPTION OF THE DRAWINGS

The objects, features and advantages of the present invention will be apparent to one skilled in the art, in view of the following detailed description in which:

FIG. 1 illustrates a conceptual diagram of a typical computer operating system.

FIG. 2 illustrates a state diagram of an infrared sniffer program.

FIG. 3 illustrates a flow diagram describing how the embodiment of a dual-use serial port driver operates within the context of a portable computer system having an infrared port.

### DETAILED DESCRIPTION OF THE PREFERRED EMBODIMENT

A method and apparatus for sharing a serial port is disclosed. In the following description, for purposes of explanation, specific nomenclature is set forth to provide a thorough understanding of the present invention. However, it will be apparent to one skilled in the art that these specific details are not required in order to practice the present invention. For example, the present invention has been described with reference to a serial port that is shared between an infrared sniffer program and application programs. However, the same techniques can easily be applied to other types of computer hardware resources and other types of programs that need frequent access to a scarce computer hardware resource.

### Operating System Architecture

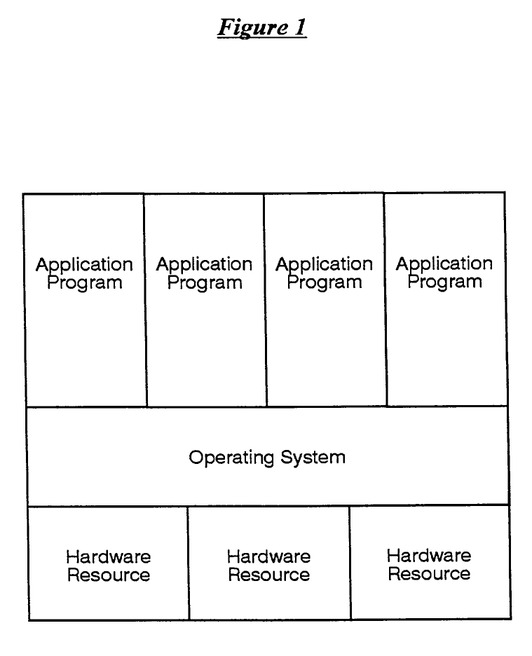

An operating system is a computer program that provides a consistent simplified interface between computer application programs and computer hardware. FIG. 1 illustrates a conceptual diagram of computer system. Referring to FIG. 1, the operating system is positioned between application programs and the computer hardware.

In modern operating systems, the operating system shares the computer hardware resources among several concurrently executing application programs. One method of sharing hardware resources is to require each application program to request the operating system for access to a particular hardware resource when it is needed and then return control of the hardware resource back to the operating system when it is no longer needed. However, such a system does not work if an unruly application does not return a hardware resource back to the operating system. Furthermore, some hardware resources need to be monitored by one application program but occasionally used by another application program.

### Transparently Shared Resources

The present invention introduces a new type of device driver that allows a first application to control hardware resource until it is requested by a second application program. When requested by another application, the first application enters an idle state. When the second application releases the hardware resource, the first application then resumes execution.

Sharing Serial Port Driver

The present invention will be described with reference to a serial port within a portable computer system. The serial port is switchably coupled to a infrared detector such that the infrared detector may use the serial port or other peripherals may use the serial port. To determine if there are any infrared data signals, an infrared “sniffer” program couples the infrared port to the serial port and then monitors infrared data received through the serial port on the portable computer system to determine if any valid infrared signals are being received. Although the teachings are described with reference to a serial port used by an infrared sniffer, the same teachings can be applied to other hardware resources and other application programs.

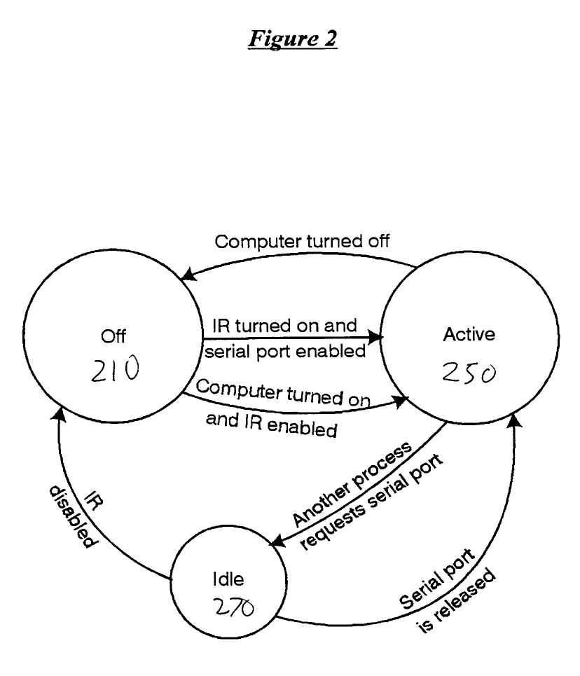

FIG. 2 illustrates a state diagram of an infrared sniffer program. Referring to FIG. 2, when the portable computer system is off or the infrared detection feature is turned off, then the infrared sniffing portion of the serial port driver is in an off state 210. When the portable computer system is turned on or the infrared detection feature is turned on, the infrared sniffing portion of the serial port driver enters an active state 250. In the active state 250, the sniffer portion of the serial port driver monitors an infrared detector to determine if there are any infrared signals. However, if another application requests the operating system for access to the serial port, then the serial port driver enters an idle state 270. The sniffer portion of the serial port driver remains in the idle state 270 until the serial port is released and the sniffer returns to the active state 250 or the infrared feature is turned off and the sniffer enters the off state 210.

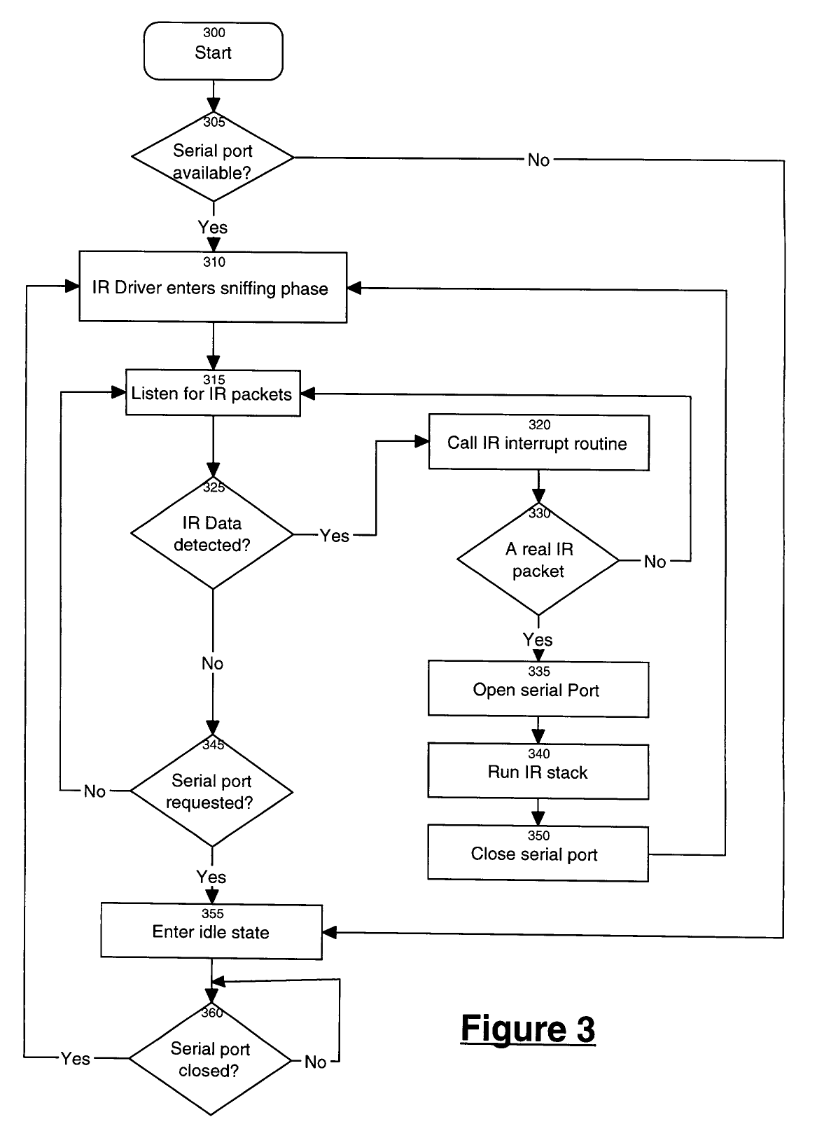

FIG. 3 illustrates a flow diagram describing how the sniffer portion of the serial port driver operates. The sniffer first determines if the serial port is being used by another application at step 305. If the serial port is not available, then the sniffer proceeds to the idle state 355. If the serial port is available, then the serial port driver enters the active mode at step 310. To enter the active mode, the sniffer connects the serial port hardware to an infrared detector at step 315. With an infrared detector connected to the serial port, any infrared signals directed toward the system will be received on the serial port.

In the sniffing mode, the infrared sniffer monitors an infrared detector coupled to the serial port to determine if any infrared data is detected at step 325. The infrared sniffer also checks to see if any other application program has requested access to the serial port at step 345. If another application program has requested the serial port, the sniffer enters the idle state 355. When entering the idle state at step 355, the infrared sniffer disconnects the infrared detector from the serial port. Instead, a normal external serial port interface is coupled to the serial port hardware such that the computer system can communicate with hardware connected to the serial port interface. The infrared sniffer remains in the idle state until the other application releases control of the serial port.

Referring back to step 325, if an infrared data signal has been detected, then the sniffer calls an infrared interrupt routine at step 320. The infrared interrupt routine processes the infrared data signal to determine if the received infrared data signal is a real valid infrared packet at step 330. In one embodiment, a chain of different infrared protocol routines can examine the same incoming data to see if the data matches any known infrared protocol. Thus, more than one application can look for incoming data. If the received infrared data signal is not identified as an infrared packet in a known protocol, then the sniffer goes back to step 315 to listen for more infrared data signals.

If a valid infrared packet is detected, then the infrared interrupt routine takes control of the serial port at step 335 to begin an infrared communication session. Next, the infrared interrupt routine activates an infrared protocol stack at step 340.

In the embodiment where there are more than one infrared protocol, the infrared protocol stack that matches the identified protocol is activated. Thus one protocol stack is given exclusive access to the infrared port. Once the infrared protocol stack has been activated, the infrared interrupt routine passes the valid infrared data packet to the infrared protocol stack for further processing of the infrared data packet.

After the infrared protocol stack has completed its infrared communication session , the infrared protocol stack closes the serial port at step 350. Control of the serial port is thus returned to the infrared sniffer by returning to step 310.

The foregoing has described a method for sharing a hardware resource in a computer system. It is contemplated that changes and modifications may be made by one of ordinary skill in the art, to the materials and arrangements of elements of the present invention without departing from the scope of the invention.

We claim:

1. A method of sharing a hardware resource in a computer system, said method comprising the steps of:
monitoring a hardware device for activity, activating an examination routine upon detection of activity on said hardware device;
requesting access to said hardware device from a first application;
providing access to said hardware device to said first application;
releasing control of said hardware device from said first application; and
returning to said step of monitoring after releasing control of said hardware device from said first application.

2. The method as claimed in claim 1 wherein activating said examination routine comprises determining if a received data is recognized as a first known protocol.

3. The method as claimed in claim 2, said method further comprising the step of:
activating a first protocol stack to process said first known protocol.

4. The method as claimed in claim 2 wherein activating said examination routine comprises determining if a received data is recognized as a second known protocol.

5. The method as claimed in claim 4, said method further comprising the step of:
activating a first protocol stack to process said second known protocol.

6. The method as claimed in claim 3, said method further comprising the step of:
providing access to said hardware device to said first protocol stack.

7. The method as claimed in claim 6, said method further comprising the step of:
passing said received data to a first protocol stack.

8. An computer apparatus, said computer apparatus comprising:
an operating system, said operating system controlling a set of hardware resources in said computer apparatus;
a hardware resource, said hardware resource controlled by said operating system; and
a sniffing routine under control of said operating system, said sniffing routine monitoring said hardware resource when no other application programs needs said hardware resource.

9. The apparatus as claimed in claim 8 wherein said sniffing routine determines if data received from said hardware resource is recognized as a first known protocol.

10. The apparatus as claimed in claim 9 wherein said sniffing routine activates a first protocol stack to process said first known protocol.

11. The apparatus as claimed in claim 9 wherein said sniffing routine determines if data received from said hardware resource is recognized as a second known protocol.

12. The apparatus as claimed in claim 11 wherein said sniffing routine activates a first protocol stack to process said second known protocol.

13. The apparatus as claimed in claim 10 wherein said operating system provides access to said hardware resource to said first protocol stack.

14. The apparatus as claimed in claim 8 wherein said hardware resource comprises a serial port.

15. The apparatus as claimed in claim 14 wherein said serial port is switchably coupled to an infrared detector.

16. An apparatus, said apparatus comprising:
a serial port, said serial port switchably connected to an infrared detector;
and
a serial port driver, said serial port driver allowing an infrared sniffer program to monitor for infrared signals when no other application programs need the serial port.
